(19) United States
(12) Patent Application Publication
(10) Pub. No.: US 2014/0197609 A1
(43) Pub. Date: Jul. 17, 2014

(54) Hand Tool Plate Clamp

(71) Applicant: A-TINA TOOLS CO., LTD., Taichung City (TW)

(72) Inventor: Kun-Chen Chen, Taichung City (TW)

(73) Assignee: A-TINA TOOLS CO., LTD., Taichung City (TW)

(21) Appl. No.: 13/742,706

(22) Filed: Jan. 16, 2013

(51) Int. Cl. B23B 31/107

(52) U.S. Cl. CPC B23B 31/1074
USPC 279/97

(57) ABSTRACT

A hand tool plate clamp has a connecting shaft, a locking column, an abutting tube, a spring, and a sliding case. The connecting shaft has an insertion slot and a column hole. The insertion slot is mounted on an end of the connecting shaft and the column hole communicates with the insertion slot. The locking column is inserted movably in the column hole. The abutting tube is mounted on and abuts on the connecting shaft. The spring abuts on the abutment ring. The sliding case is mounted on the connecting shaft and the abutting tube. The sliding case abuts on the spring and the locking column Accordingly, the sliding case can be slid movably, and the spring can enable the sliding case to fix the locking column.

### BACKGROUND OF THE INVENTION

1. Field of the Invention

The present invention relates to a hand tool clamp, and more particularly to a hand tool plate clamp.

2. Description of Related Art

With reference to FIG. 8, a conventional hand tool has a handle 80 and a hand tool plate 90. The handle 80 is elongated and has an insertion slot 81, an insertion hole 82, a first bolt 83, and a second bolt 84. The hand tool plate 90 has an insertion hole 91. The insertion hole 91 of the hand tool plate 90 is formed in an end of the hand tool plate 90. The hand tool plate 90 is inserted in the insertion slot 81, and the insertion hole 81 of the handle 80 is aligned with the insertion hole 91 of the hand tool plate 90. The first bolt 83 is inserted in the insertion hole 91 of the hand tool plate 90 and the insertion hole 82 of the handle 80. The first bolt 83 has an external thread, and the second bolt 84 has an internal thread. The first bolt 83 is screwed and combined with the second bolt 84. A cross section of an end of the first bolt 83 and a cross section of an end of the second bolt 84 opposite the insertion hole 82 of the handle 80 are both larger than a cross section of the insertion hole 82 of the handle 80, such that the hand tool plate 90 will not fall off from the insertion slot 81. Users can hold the handle 80 to target the hand tool plate 90 at a working point.

To replace the hand tool plate 90, the first bolt 83 and the second bolt 84 can be separated from each other with a screwdriver or other tools. A new or different hand tool plate 90 is inserted in the insertion slot 81, and then the first bolt 83 and the second bolt 84 are respectively inserted in the insertion hole 91 of the hand tool plate 90 and the insertion hole 81 of the handle 80, and are combined with each other again. However, to replace the hand tool plate 90, a screwdriver or another tool is needed and this is inconvenient in use.

To overcome the shortcomings of the conventional hand tool, the present invention provides a hand tool plate clamp to mitigate or obviate the aforementioned problems.

### SUMMARY OF THE INVENTION

The main object of the present invention is to provide an improved hand tool plate clamp, which comprises a connecting shaft, a locking column, an abutting tube, a spring, and a sliding case. The connecting shaft has a connecting segment, a shaft flange formed on an end of the connecting segment, an inserted segment co-axially connected with the end of the connecting segment and adjacent to the shaft flange, an insertion slot defined longitudinally in an end of the inserted segment, and a column hole formed radially through the inserted segment and communicating with the insertion slot.

The locking column is inserted axially and movably in the column hole and has a column flange formed on an end of the locking column and the connecting shaft, an abutted surface formed on a side of the column flange, and a locking end being tapered and defined on the other end of the locking column opposite to the abutted surface.

The abutting tube is mounted around the connecting shaft and has an abutting portion protruding inwardly from an end of the abutting tube and abutting a side of the shaft flange, and a pressing portion protruding outwardly from the other end of the abutting tube.

The spring is mounted around and on the abutting tube and has an end abutting the pressing portion. The sliding case is mounted around the connecting shaft, the locking column, the abutting tube and the spring, and has an encasing segment being tubular and mounted around the connecting shaft movably, an abutting segment connected annularly with an end of the encasing segment, an abutting surface formed on an inner surface of the abutting segment and abutting on the abutted surface of the locking column, an accommodating segment connected annularly with an end of the abutting segment opposite to the encasing segment, and the accommodating segment accommodating the abutting tube and the spring, an abutment ring mounted around and in the accommodating segment and having an inside wall formed around and inside the abutment ring and abutting tightly on the abutting tube, an outside wall formed around and outside the abutment ring and abutting tightly on the accommodating segment, and a side abutting the other end of the spring opposite to the pressing portion.

The sliding case can be slid and the abutment ring pushes the spring. The abutted surface of the locking column does not abut the abutting surface of the sliding case, and the locking column cannot be fixed in the column hole of the connecting shaft. Then different hand tool plates can be removed or mounted in the insertion slot.

Other objects, advantages, and novel features of the invention will become more apparent from the following detailed description when taken in conjunction with the accompanying drawing.

### BRIEF DESCRIPTION OF THE DRAWINGS

FIG. 1 is a perspective view of a preferred embodiment of a hand tool plate clamp in accordance with the present invention;

FIG. 2 is an exploded perspective view of the hand tool plate clamp of FIG. 1;

FIG. 3 is a side view in partial section of the hand tool plate clamp of FIG. 1;

FIG. 4 shows operational side views in partial section of the hand tool plate clamp of FIG. 1;

FIG. 5 is an operational perspective view of the hand tool plate clamp of FIG. 1 combined with a blade plate;

FIG. 6 is an operational perspective view of the hand tool plate clamp of FIG. 1 combined with a saw plate;

FIG. 7 is an operational perspective view of the hand tool plate clamp of FIG. 1 combined with a rasp; and

FIG. 8 is a respective view of a conventional hand tool.

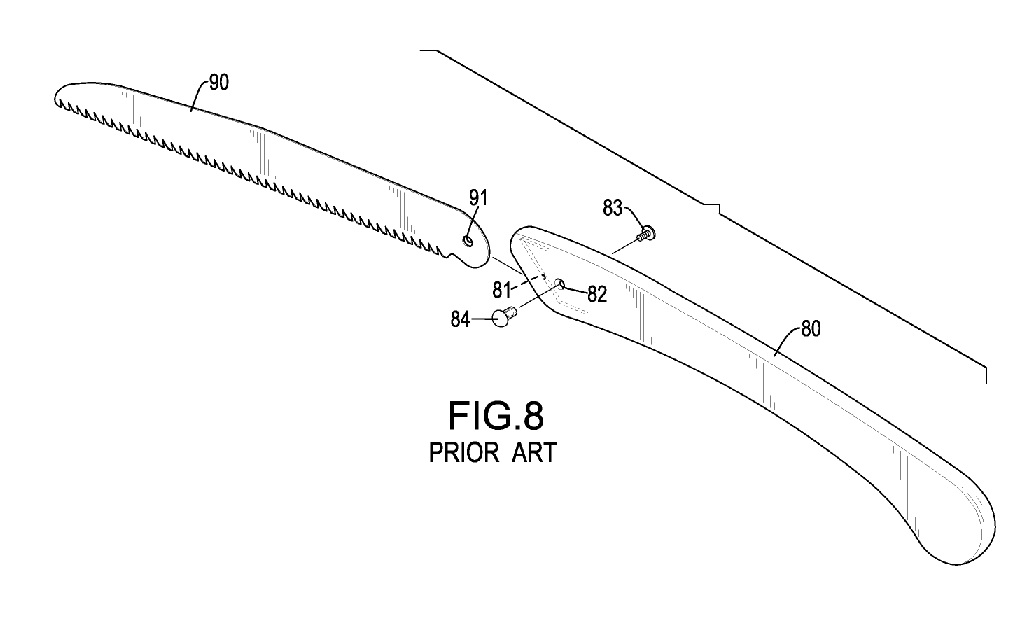

### DETAILED DESCRIPTION OF PREFERRED EMBODIMENT

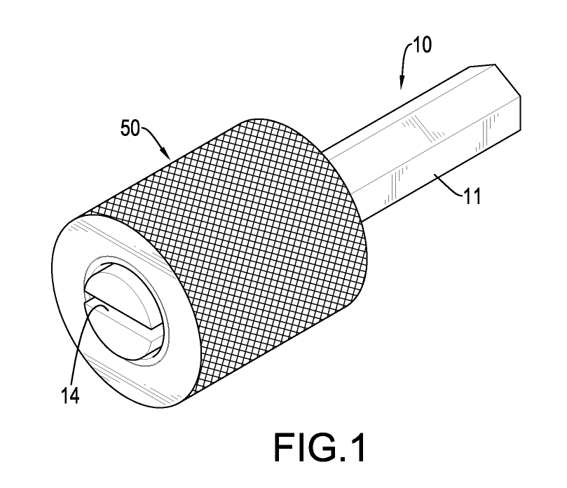

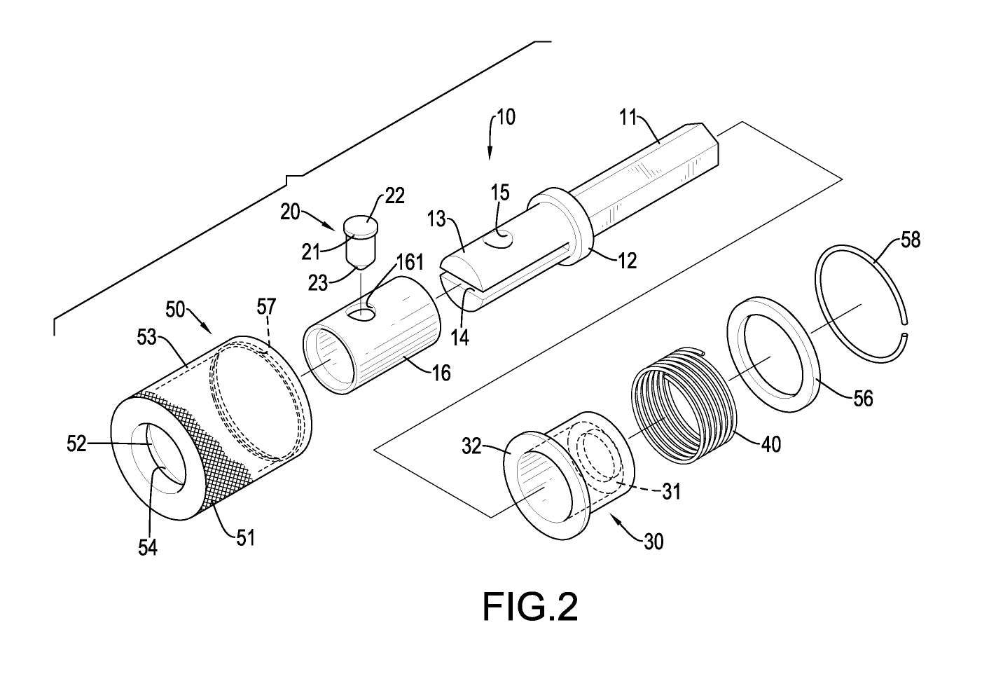

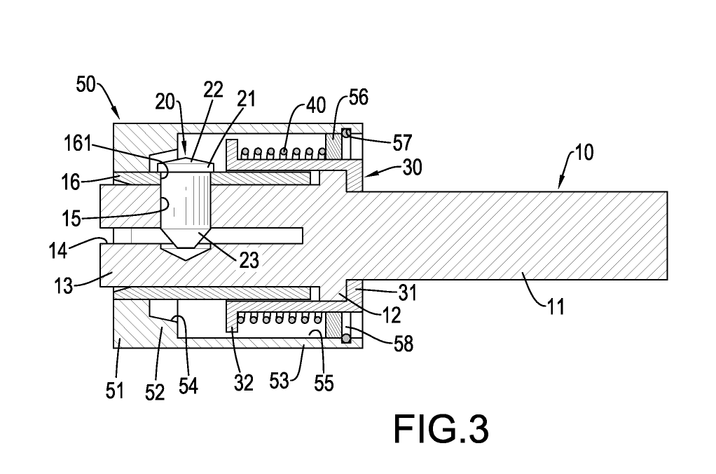

With reference to FIGS. 1 to 3, a preferred embodiment of a hand tool plate clamp in accordance with the present invention comprises a connecting shaft 10, a locking column 20, an abutting tube 30, a spring 40, and a sliding case 50.

The connecting shaft 10 comprises a connecting segment 11, a shaft flange 12, an inserted segment 13, an insertion slot 14, a column hole 15, and a fixing tube 16. The shaft flange 12 is formed annularly on an end of the connecting segment 11. The inserted segment 13 is connected with the end of the connecting segment 11 and is adjacent to the shaft flange 12. The insertion slot 14 is defined axially or longitudinally in an end of the inserted segment 13 opposite to the shaft flange 12, and is defined radially through two sides of the inserted segment 13. The column hole 15 is formed radially through the inserted segment 13 and communicates with the insertion slot 14. The fixing tube 16 is mounted around the inserted segment 13, and an axial length of the fixing tube 16 is corresponding to an axial depth of the insertion slot 14. The fixing tube 16 has a column hole 161 that is formed radially in the fixing tube 16. An axial direction of the column hole 161 of the fixing tube 16 is the same as a radial direction of the inserted segment 13, and the column hole 161 of the fixing tube 16 is aligned with the column hole 15 of the connecting shaft 10. Alternatively, the insertion slot 14 does not extend through the sides of the inserted segment 13, and then the fixing tube 16 can be omitted.

The locking column 20 is inserted axially and movably in the column hole 15 of the connecting shaft 10 and the column hole 161 of the fixing tube 16. The locking column 20 comprises a column flange 21, an abutted surface 22, and a locking end 23. The column flange 21 is annularly formed on an end of the locking column 20 and abuts the fixing tube 16. The abutted surface 22 is formed on a side of the column flange 21 and is inclined from a periphery to a center of the column flange 21. The locking end 23 is opposite to the abutted surface 22, is tapered and extends through the column hole 15 of the connecting shaft 10.

The abutting tube 30 is mounted around the fixing tube 16 and the shaft flange 12. The abutting tube 30 has an abutting portion 31 and a pressing portion 32. The abutting portion 31 is formed on an end of the abutting tube 30, and the pressing portion 32 is formed on the other end of the abutting tube 30. The abutting portion 31 protrudes annularly and inwardly from the end of the abutting tube 30 and abuts a side of the shaft flange 12 opposite to the fixing tube 16. The pressing portion 32 protrudes annularly and outwardly from the end of the abutting tube 30. The spring 40 is mounted around the abutting tube 30 and an end of the spring 40 abuts the pressing portion 32.

The sliding case 50 has an encasing segment 51, an abutting segment 52, an accommodating segment 53, an abutment surface 54, a space 55, an abutment ring 56, a buckle groove 57, and a buckle 58. The encasing segment 51 is tubular. The encasing segment 51 is mounted around the fixing tube 16 movably. Alternatively, when the fixing tube 16 is omitted, the encasing segment 51 is mounted movably around the inserted segment 13. The abutting segment 52 is annularly connected with an end of the encasing segment 51, and the accommodating segment 53 is annularly connected with an end of the abutting segment 52 opposite to the encasing segment 51. An inner diameter of the accommodating segment 53 is larger than an inner diameter of the abutting segment 52, and the inner diameter of the abutting segment 52 is larger than an inner diameter of the encasing segment 51. The abutting surface 54 of the sliding case 50 is formed on an inner surface of the abutting segment 52 and faces the fixing tube 16. The abutting surface 54 of the sliding case 50 abuts the abutted surface 22 of the locking column 20, and the abutting surface 54 is inclined and corresponds to the abutted surface 22 of the locking column 20. The space 55 is formed in the accommodating segment 53 and holds the spring 40 and the pressing portion 32 inside. The abutment ring 56 is mounted in the space 55. An inner wall of the abutment ring 56 abuts tightly on the abutting tube 30, and an outer wall of the abutment ring 56 abuts tightly on the accommodating segment 53. A side of the abutting ring 56 abuts an end of the spring 40 opposite to the pressing portion 32. The buckle groove 57 is formed in an end of the accommodating segment 53 corresponding to the other side of the abutment ring 56 opposite to the spring 40. The buckle 58 is mounted in the buckle groove 57 and abuts the abutment ring 56.

The sliding case 50, the fixing tube 16, the inserted segment 13, the shaft flange 12, the abutting tube 30, and the abutment ring 56 may be round or in any possible shape in cross section; the present invention does not limit the shapes thereof. The shapes of the abutting surface 54 of the sliding case 50 and the abutted surface 22 of the locking column 20 are also not limited in the present invention, as long as the abutting surface 54 of the sliding case 50 can abut the abutted surface 22 of the locking column 20 to ensure the locking column 20 can lock a hand tool plate firmly. The buckle 58 abuts on the abutment ring 56 to keep the abutment ring 56 from being separated from the abutting tube 30 with a force of the spring 40. The buckle 58 may be omitted, when the abutment ring 56 is pressed tightly into the sliding case 50 and the abutting tube 30.

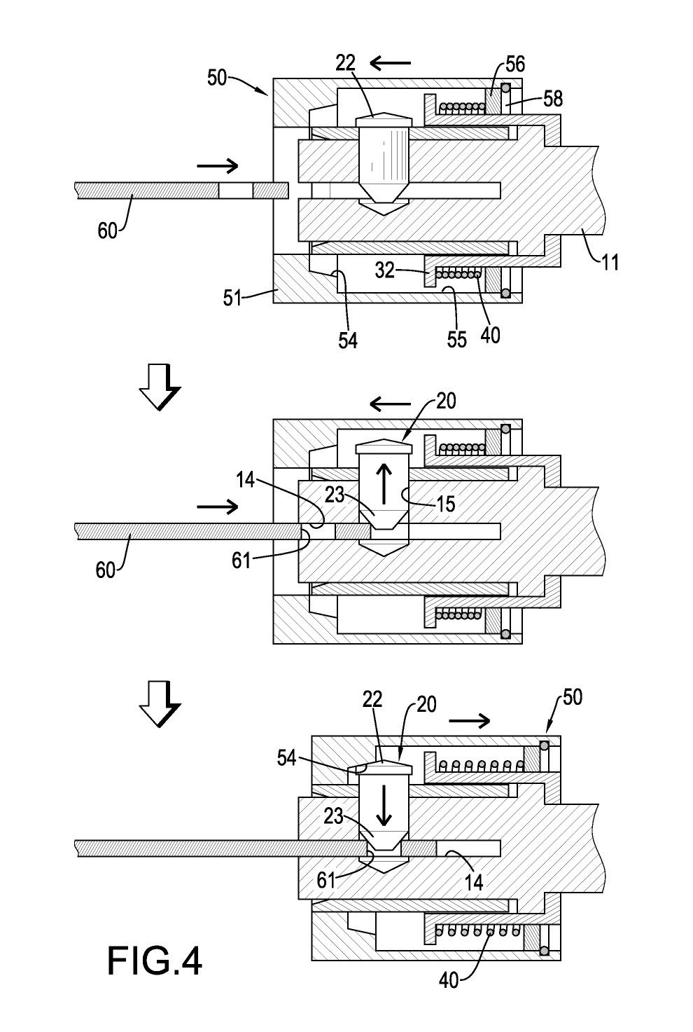

With reference to FIG. 4, in use, the sliding case 50 is moved in a direction opposite to the connecting segment 11 to push the abutment ring 56 to compress the spring 40, and then the abutting surface 54 of the sliding case 50 departs from the abutment position on the abutted surface 22 of the locking column 20. A hand tool plate 60 is inserted in the insertion slot 14. The hand tool plate 60 has an insertion hole 61 that is aligned with the locking column 20 when the hand tool plate 60 is inserted into the insertion slot 14. The hand tool plate 60 pushes the locking end 23 to enable the locking end 23 to depart from the insertion slot 14 and retract into the column hole 15 of the connecting shaft 10, and the locking column 20 is aligned with the insertion hole 61. Then, the sliding case 50 is released and the force of the spring 40 pushes the abutment ring 56 to return. The abutting surface 54 of the sliding case 50 abuts against the abutted surface 22 of the locking column 20 to ensure the locking end 23 does not depart from the insertion hole 61, such that the hand tool plate 60 is mounted in the insertion slot 14 firmly. The fixing tube 16 can fix the hand tool plate 60, such that the hand tool plate 60 can be kept from rotating along the locking column 20 in the insertion slot 14. Alternatively, the fixing tube 16 can be omitted when the insertion slot 14 does not extend through the sides of the inserted segment 13.

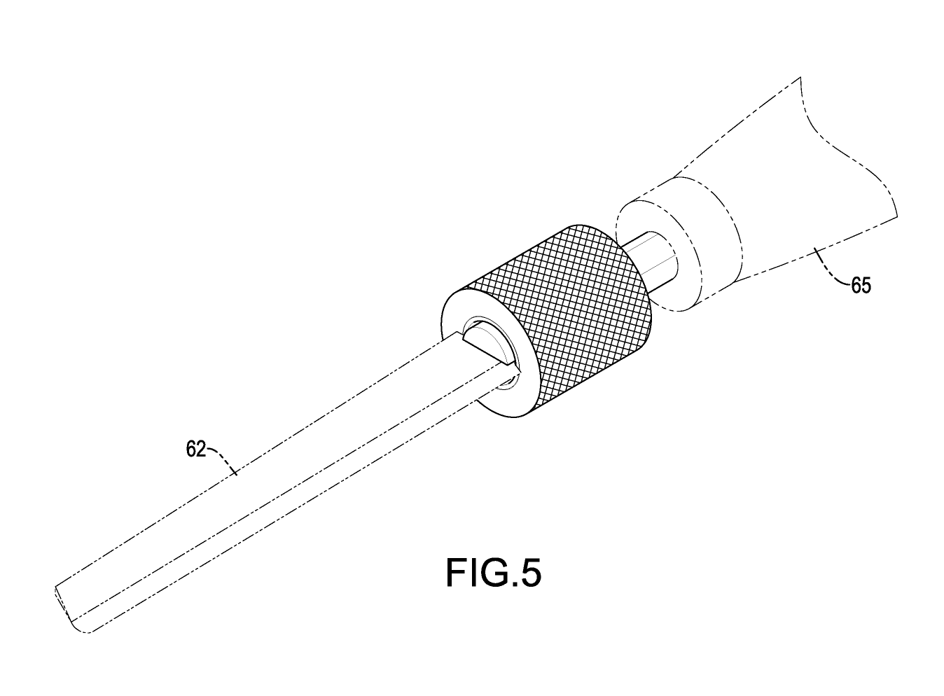

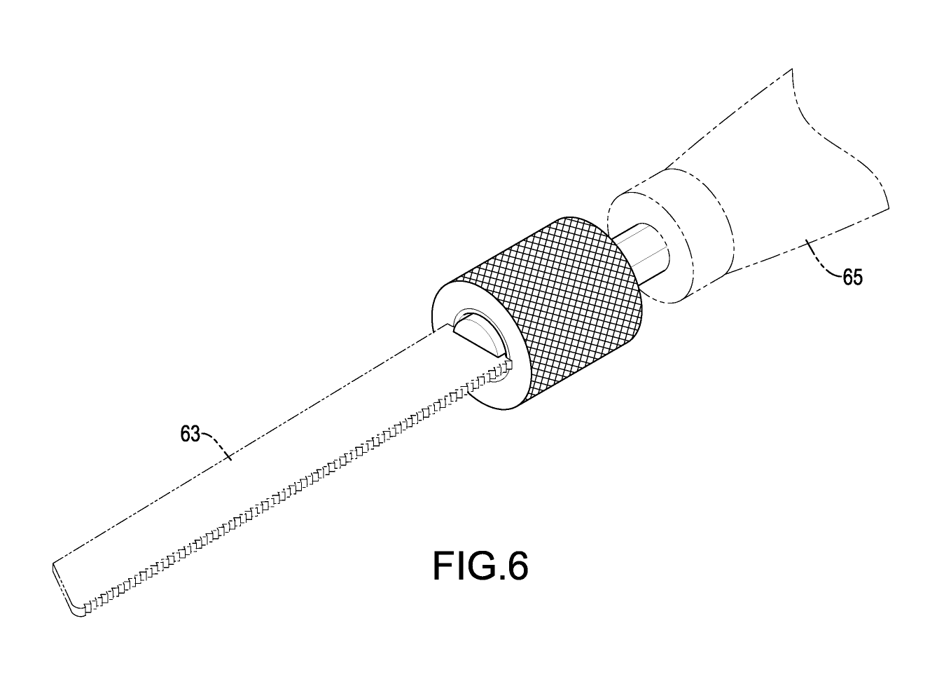

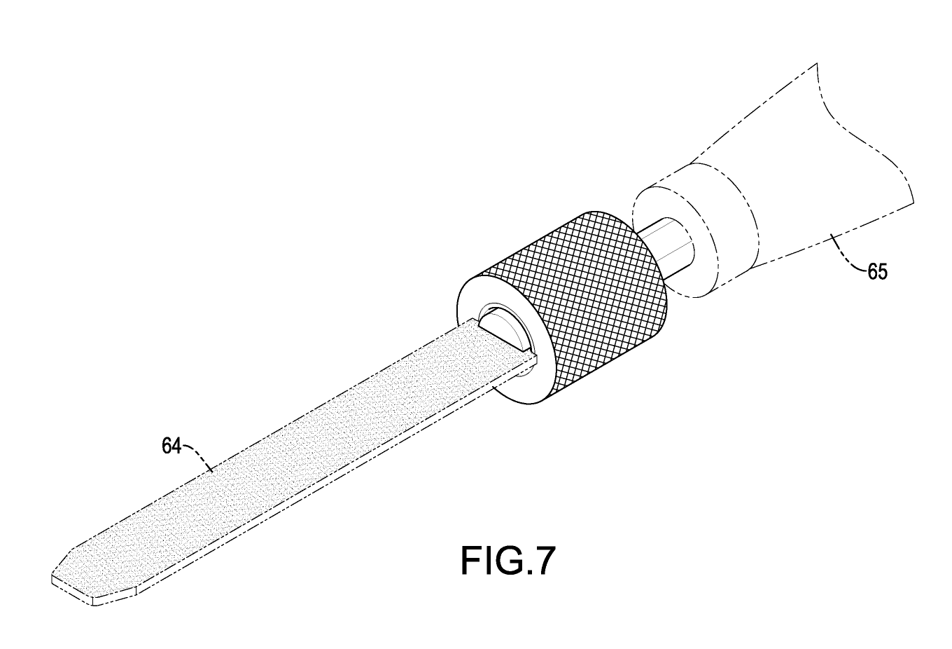

The hand tool plate 60 can be replaced easily by the above procedures. The preferred embodiment can clamp different hand tool plates 60, for example: a blade plate 62 with reference to FIG. 5, a saw plate 63 with reference to FIG. 6, and a rasp plate 64 with reference to FIG. 7. The connecting segment 11 is connected with a handle 65 detachably or integrally.

What is claimed is:

1. A hand tool plate clamp comprising
a connecting shaft comprising
a connecting segment;
a shaft flange formed on an end of the connecting segment;
an inserted segment co-axially connected with the end of the connecting segment and adjacent to the shaft flange;
an insertion slot defined longitudinally in an end of the inserted segment; and
a column hole formed radially through the inserted segment and communicating with the insertion slot;
a locking column inserted axially and movably in the column hole and having
a column flange formed on an end of the locking column and abutting the connecting shaft;
an abutted surface formed on a side of the column flange;
a locking end being tapered and defined on the other end of the locking column opposite to the abutted surface;
an abutting tube mounted around the connecting shaft and having
an abutting portion protruding inwardly from an end of the abutting tube and abutting a side of the shaft flange; and
a pressing portion protruding outwardly from the other end of the abutting tube;
a spring mounted around and on the abutting tube and having
an end abutting the pressing portion; and
a sliding case mounted around the connecting shaft, the locking column, the abutting tube and the spring, and having
an encasing segment being tubular and mounted around the connecting shaft movably;
an abutting segment connected annularly with an end of the encasing segment;
an abutting surface formed on an inner surface of the abutting segment and abutting the abutted surface of the locking column;
an accommodating segment connected annularly with an end of the abutting segment opposite to the encasing segment, and the accommodating segment accommodating the abutting tube and the spring;
an abutment ring mounted around and in the accommodating segment and having
an inside wall formed around and inside the abutment ring and abutting tightly on the abutting tube;
an outside wall formed around and outside the abutment ring and abutting tightly on the accommodating segment; and
a side abutting the other end of the spring opposite to the pressing portion.

2. The hand tool plate clamp as claimed in claim 1, wherein
the insertion slot is defined radially through two sides of the inserted segment;
the connecting shaft further has
a fixing tube mounted around the inserted segment and abutting the column flange and the encasing segment and having
a column hole formed radially in the fixing tube and aligned with the column hole of the connecting shaft.

3. The hand tool plate clamp as claimed in claim 2, wherein
the abutting surface of the sliding case is inclined with an outer wall of the fixing tube, and
the abutted surface of the locking column is inclined with the outer wall of the fixing tube and an inclined angle of the abutted surface of the locking column is corresponding to an inclined angle of the abutting surface of the sliding case.

4. The hand tool plate clamp as claimed in claim 3, wherein the shaft flange protrudes from the connecting segment annularly.

5. The hand tool plate clamp as claimed in claim 4, wherein the sliding case, the fixing tube, the inserted segment, the shaft flange, the abutting tube, and the abutment ring are round in cross section.

6. The hand tool plate clamp as claimed in claim 1, wherein the sliding case further has
a buckle groove formed in an end of the accommodating segment opposite to the abutting segment, and defined in the other side of the abutment ring opposite to the spring; and
a buckle mounted in the buckle groove and abutting the abutment ring.

7. The hand tool plate clamp as claimed in claim 2, wherein the sliding case further has
a buckle groove formed in an end of the accommodating segment opposite to the abutting segment, and defined in the other side of the abutment ring opposite to the spring; and
a buckle mounted in the buckle groove and abutting the abutment ring.

8. The hand tool plate clamp as claimed in claim 3, wherein the sliding case further has
a buckle groove formed in an end of the accommodating segment opposite to the abutting segment, and defined in the other side of the abutment ring opposite to the spring; and
a buckle mounted in the buckle groove and abutting the abutment ring.

9. The hand tool plate clamp as claimed in claim 4, wherein the sliding case further has
a buckle groove formed in an end of the accommodating segment opposite to the abutting segment, and defined in the other side of the abutment ring opposite to the spring; and
a buckle mounted in the buckle groove and abutting the abutment ring.

10. The hand tool plate clamp as claimed in claim 5, wherein the sliding case further has
a buckle groove formed in an end of the accommodating segment opposite to the abutting segment, and defined in the other side of the abutment ring opposite to the spring; and
a buckle mounted in the buckle groove and abutting the abutment ring.
